(19) United States
(12) Patent Application Publication
(10) Pub. No.: US 2006/0137007 A1
(43) Pub. Date: Jun. 22, 2006

(54) Revoking a permission for a program

(75) Inventors: Lauri Paatero, Helsinki (FI); Antti Hayrynen, Oulu (FI); Liiisa Peltonen, Vantaa (FI); Vesa Tervo, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/015,099

(22) Filed: Dec. 16, 2004

(51) Int. Cl. G06F 12/14

(52) U.S. Cl. 726/22

(57) ABSTRACT

A device and a method for revoking a permission of an access controlled program are provided. The method includes executing an access controlled program by a processor at a device, determining if a permission of the access controlled program at the device needs to be revoked, and requesting a new permission for the access controlled program at the device if the permission is determined to need revocation. For example, revocation of the permission may result when a specified time interval has elapsed during execution of the access controlled program. As another example, revocation of the permission may result when the number of access control program instructions executed by a processor exceeds a predetermined use threshold. The access controlled program may be a Mobile Information Device Profile program also known as a MIDlet.

### FIELD OF THE INVENTION

The present invention is related to setting a permission for access to a device. More specifically, the present invention relates to monitoring the permission for a program executing at the device and possibly revoking the permission of the program.

### BACKGROUND OF THE INVENTION

In addition to processing voice calls from both wired and wireless phones, handheld communication devices now also communicate with other types of devices such as computers of all form factors, Personal Digital Assistants (PDAs) or handheld PCs, Integrated Communication Devices (ICDs), etc. Additionally, communication devices have merged the capabilities of cellular telephones, PDAs, ICDs, and computing devices and now provide increasingly sophisticated programs. Programs provide the communication device with the ability to perform a wide variety of tasks including drafting documents, preparing presentations, creating movies and music, taking pictures, maintaining schedules, playing games, conducting e-commerce functions, messaging, etc.

The typical computer operating system provides for a multiple user computing environment that restricts user access to files in a file system based on the group to which the user belongs and on the group access rights defined for a specific file or folder. However, these access control systems are not easily understood or configured by the typical communication device user. Previously, the access control system was defined by a system administrator skilled in the setting of permissions for users and groups. Today, the user of a device often specifies the device access permissions themselves. The user may have little or no computer skill training. As a result, many users may choose to avoid defining the access permissions altogether or may define the access permissions incorrectly. Additionally, the existing paradigm of multiple access is associated with multiple users physically accessing the same device. In accessing communication devices, only one user generally has physical control over the communication device.

Additionally, both the Mobile Information Device Profile (MIDP) and the Symbian Operating System (OS) utilize an identity based rights management system for permission to execute an individual program or access to certain software modules at a device. However, neither identity based rights management system provides for a dynamic evolution of program access rights as a user executes the program. For example, some programs may attempt to access very sensitive information and thus, should have additional protections for the user at the device to insure that the access should be granted. Thus, what is needed is an easily understandable method and device for monitoring access permissions of a program executing at a device particularly in a mobile communication device environment.

### SUMMARY OF THE INVENTION

An exemplary embodiment of the invention relates to a method of revoking a permission of an access controlled program code. The method includes, but is not limited to, executing an access controlled program by a processor at a device, determining if a permission of the access controlled program at the device needs to be revoked, and requesting a new permission for the access controlled program at the device if the permission is determined to need revocation.

Another exemplary embodiment of the invention relates to one or more computer-readable media having computer-readable instructions stored thereon that, upon execution by a processor, cause the processor to revoke a permission of an access controlled program. The instructions are configured to execute an access controlled program, to determine if a permission of the access controlled program needs to be revoked, and to request a new permission for the access controlled program at the device if the permission is determined to need revocation.

Still another exemplary embodiment of the invention relates to a device for revoking a permission of an access controlled program. The device includes, but is not limited to, an access controlled program, a memory, and a processor. The access controlled program includes, but is not limited to, computer-readable instructions configured to execute an access controlled program, to determine if a permission of the access controlled program needs to be revoked, and to request a new permission for the access controlled program at the device if the permission is determined to need revocation. The memory stores the access controlled program. The processor couples to the memory and executes the access controlled program.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is an overview diagram of a system in accordance with an exemplary embodiment.

FIG. 2 is a block diagram of a device in accordance with an exemplary embodiment.

FIG. 3 is a flowchart in accordance with an exemplary embodiment.

### DETAILED DESCRIPTION OF THE INVENTION

Various authentication mechanisms have been developed. For example, the HyperText Transfer Protocol (HTTP) authentication mechanisms include Basic authentication, Digest authentication and custom authentication. As known to those skilled in the art, other authentication schemes also may be used. HTTP provides a challenge-response authentication mechanism that may be used by a server to challenge a client request and by a client to provide authentication information. An extensible, case-insensitive token may also be used to identify the authentication scheme (i.e., Basic or Digest). The authentication scheme may be followed by a comma-separated list of attribute-value pairs, for example, that carry the parameters necessary to authenticate the client with the server using the specified authentication scheme.

The Basic authentication mechanism is based on the concept that the client authenticates itself with a valid username and password before the server performs the requested service. By way of example, to receive authorization, the client sends the username and password separated by a single colon character within a base 64 encoded string. A client may preemptively send the corresponding Authorization header with the request to access a resource at the server instead of waiting for the challenge. The server device may confirm the validity of the password by looking up the password that corresponds to the submitted username. If the passwords match, the client device is authenticated. To challenge the authorization of a user to access an additional program functionality or to continue to access a program, for example, similar authentication or verification mechanisms may be used.

Java™ is a software technology developed to provide a common base for running programs across a wide variety of computing platforms. Java consists of a programming language and a run-time environment. Java programs can run on servers, personal computers, mobile phones, and other devices. Because the capabilities of these computing platforms vary, Java has evolved into 3 editions: Java 2 Enterprise Edition (J2EE™), Java 2 Standard Edition (J2SE™), and Java 2 Micro Edition (J2ME™). J2EE is generally utilized for high-end business machines such as servers. J2SE is generally utilized for personal computers. J2ME is generally utilized for smaller handheld devices such as mobile phones, two-way pagers, PDAs, ICDs, etc. Thus, J2ME is designed for use in resource-constrained mass-market consumer devices.

The J2ME specification defines configurations and profiles that make up the Java technology stack. Configurations are composed of a virtual machine and a minimal set of Java programming language class libraries that provide the basic functionality for a particular range of devices that share similar characteristics, such as network connectivity and memory footprint. Currently, there are two J2ME configurations: the Connected Limited Device Configuration (CLDC) and the Connected Device Configuration (CDC). To provide a complete runtime environment targeted at specific device categories, configurations must be combined with a set of higher level Application Programming Interfaces (APIs), or profiles, that further define the program life cycle model, the user interface, and access to device specific properties. Thus, a profile is a layer on top of the configuration that provides additional APIs for a specific class of devices.

The MIDP is a “profile” of J2ME that defines a platform for dynamic networked programs and is designed for resource constrained devices like mobile phones, two-way pagers, PDAs, ICDs, etc. The MIDP provides the core functionality required by mobile programs, including the user interface, network connectivity, local data storage, and program management. MIDP 2.0, the most recent version of MIDP, supports standardized HTTP, Secure HTTP (HTTPS) communication for the secure transmission of sensitive information. The MIDP also provides the capability for a publisher to digitally sign a program so that the end user can verify the program using a Public/Private Key Infrastructure (PKI) to maintain program integrity. Thus, developers that create programs that deal with e-commerce, banking applications, or other private data have a stable, consistent foundation on which to base their development for resource constrained devices.

The use of HTTPS leverages existing standards such as the Secure Sockets Layer (SSL) and the Wireless Transport Layer Security (WTLS) to enable the transmission of encrypted data. A MIDlet is a program that conforms to the MIDP standard. To download a MIDlet, a user browses a list of programs stored on a Web server using a device. After the program is selected, the device checks to make sure that it can run the program. If the device can run the MIDlet, the device downloads the program, and verifies and compiles the program into Java byte code to execute at the device. A MIDlet is installed and executed locally, can operate in both a networked and a disconnected mode, and has the ability to securely store and manage data locally. Security domains protect against the unauthorized access of data, programs and other network and device resources by MIDlets at the device. By default MIDlets are not trusted and are assigned to untrusted domains that prevent access to any privileged functionality at the device. To gain privileged access, a MiDlet is assigned to a specific domain defined on the device and is properly authenticated, for example, using the X.509 PKI security standard. Thus, in order for a MIDlet to be downloaded, installed, and granted associated permissions, it must be successfully authenticated at the device by the user. If and when a device determines that a MIDlet can be trusted then access is allowed as indicated by the domain policy. Thus, authentication is performed for access to the MIDlet.

Such a convenient, flexible, and secure environment is needed because the number of transactions completed using a mobile device has been consistently increasing. For example, users may now use their handheld devices to pay bills and purchase products through the Internet, the Wireless Program Protocol (WAP), the Short Messaging Service (SMS), etc. WAP is a secure specification that allows users to access information instantly using handheld wireless devices such as mobile phones, pagers, two-way radios, smartphones, PDAs, ICDs, etc. WAP supports most wireless networks and data transmission technologies that include Cellular Digital Packet Data (CDPD), Code Division Multiple Access (CDMA), Global System for Mobile Communications (GSM), Time Division Multiple Access (TDMA), etc.

The MIDP security framework provides program developers with detailed control over who can access the data and interfaces of a program executing at the device including a set of permissions and policies that are defined by the program developer in policy files that can be modified by system administrators. MIDP 2.0 utilizes the concept of trusted programs that may be permitted to use APIs that are considered sensitive and may be restricted. An untrusted MIDlet executes in the untrusted domain profile using a restricted environment where access to protected APIs or functions either is not allowed or is allowed only with explicit user permission.

Security for a trusted MIDlet is based on the relationship between a protection domain and a set of permissions. Each protection domain defines the permissions that may be granted to the MIDlet in that domain. The protection domain owner specifies how the device identifies and verifies that it can trust the MIDlet and binds it to a protection domain with the permissions that authorize access to protected APIs or functions. A permission is defined by an API or function to prevent it from being used without authorization. The protection domain includes a set of Allowed and User permissions. The set of permissions is requested by the MIDlet in “MIDlet-Permissions” and/or “MIDlet-Permissions-Opt” attributes that may be defined in a manifest file in a Java Archive (JAR) file downloaded to the device in a single HTTP transaction. The “MIDlet-Permissions” and “MIDlet-Permissions-Opt” attributes contain a list of one or more permissions for accessing the MIDlet.

The current MIDlet security mechanism assumes that a MIDlet is subject to a single protection domain and its permissible actions. Permissions are checked by the implementation prior to the invocation of the protected function. A User Permission is defined to allow the user to deny permission or to grant permission to a specific API with one of the following interaction modes: “blanket” is valid for every invocation of an API by the MIDlet until it is uninstalled or the permission is changed by the user, “session” is valid from the invocation of the MIDlet until termination of the MIDlet, and “oneshot” requires a user prompt for a permission at each invocation of the API or function.

The existing MIDlet permissions do not adequately address situations where the MIDlet executes for an extended period of time because a “session” permission level becomes essentially a “blanket permission level under these conditions. Also, the MIDlet may provide multiple functions that should each have a unique permission for better protection. As a result, a permission should be monitored as use of the MIDlet progresses. While monitoring the permission, the permission may be revoked to respond to changing functionality of the MIDlet. For example, a MIDlet associated with a banking program may allow a permission to view a bank statement and another permission to transfer funds from an account. Similarly, a MIDlet may execute for an extended period. By monitoring the permission, the permission may be revoked after a defined time period to insure that the original user maintains control of the device. Alternatively, the permission may be revoked after the processor executes a predetermined number of instructions of the access control program. Permission may be granted again after the user satisfactorily responds to a verification query.

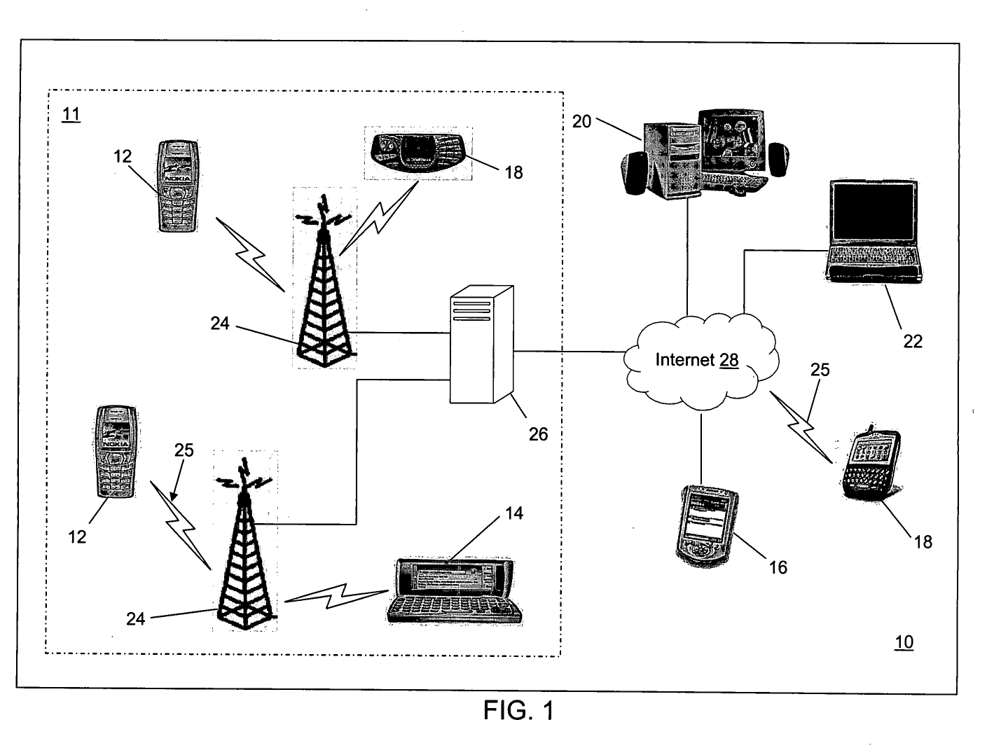

With reference to FIG. 1, a system 10 is comprised of multiple devices that can communicate through a network. The system 10 may comprise any combination of wired or wireless networks including, but not limited to, a cellular telephone network, a wireless Local Area Network (LAN), a Bluetooth personal area network, an Ethernet LAN, a token ring LAN, a wide area network, the Internet, etc. The system 10 may include both wired and wireless devices. For exemplification, the system 10 shown in FIG. 1 includes a cellular telephone network 11 and the Internet 28. Connectivity to the Internet 28 may include, but is not limited to, long range wireless connections, short range wireless connections, and various wired connections including, but not limited to, telephone lines, cable lines, power lines, etc.

The exemplary devices of system 10 may include, but are not limited to, a cellular telephone 12, a combination PDA and cellular telephone 14, a PDA 16, an ICD 18, a desktop computer 20, and a notebook computer 22. Some or all of the devices may send and receive messages and communicate with service providers through a wireless connection 25 to a base station 24. The base station 24 may be connected to a network server 26 that allows communication between the cellular telephone network 11 and the Internet 28. The system 10 may include additional devices and devices of different types including computers of all form factors.

The devices may communicate using various transmission technologies including, but not limited to, CDMA, GSM, Universal Mobile Telecommunications System (UMTS), TDMA, General Packet Radio Service (GPRS), TCP/IP, Bluetooth, IEEE 802.11, etc. A device may communicate using various media including, but not limited to, radio signals, infrared signals, laser, cable connection such as Ethernet and/or IEEE 1394, etc.

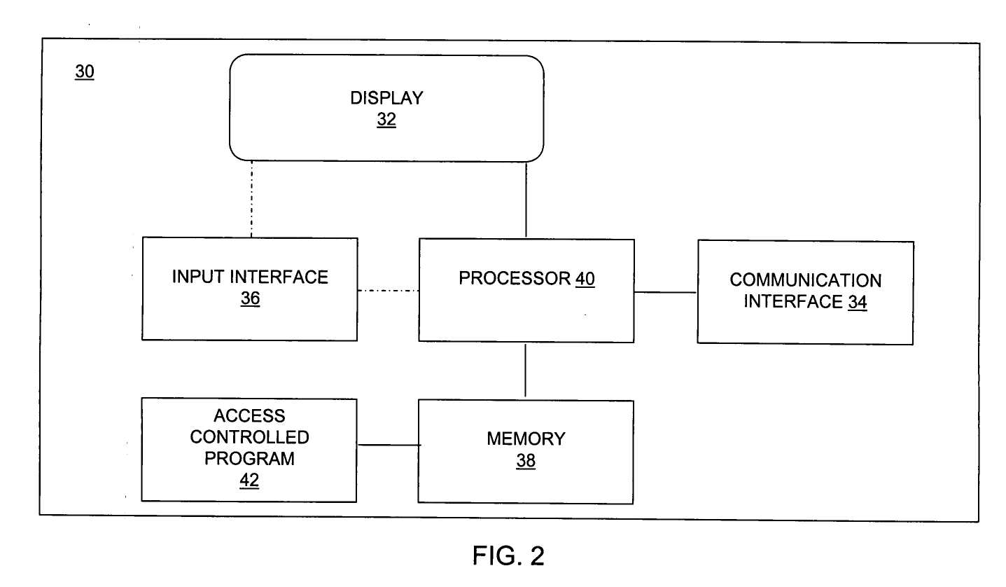

In an exemplary embodiment, the device 30, as shown in FIG. 2, comprises a display 32, a communication interface 34, an input interface 36, a memory 38, a processor 40, and an access controlled program 42. Different and additional components of the device 30 may be incorporated into the device 30 and/or the system 10. Additionally, the device 30 need not include all of the components depicted in FIG. 2.

The display 32 presents information to a user. The display 32 may be, but is not limited to, a thin film transistor (TFT) display, a light emitting diode (LED) display, a Liquid Crystal Display (LCD), a Cathode Ray Tube (CRT) display, etc.

The communication interface 34 provides an interface for receiving and transmitting calls, messages, and any other information communicable between devices. The communication interface 34 may use various transmission technologies including, but not limited to, CDMA, GSM, UMTS, TDMA, TCP/IP, GPRS, Bluetooth, IEEE 802.11, etc. to transfer content to and from the device.

The input interface 36 provides an interface for receiving information from the user for entry into the device 30. The input interface 36 may use various input technologies including, but not limited to, a keyboard, a pen and touch screen, a mouse, a track ball, a touch screen, a keypad, one or more buttons, etc. to allow the user to enter information into the device 30 or to make selections. The input interface 36 may provide both an input and output interface. For example, a touch screen both allows user input and presents output to the user.

The memory 38 is the electronic holding place for the operating system, the access controlled program 42, and/or other programs and data so that the information can be reached quickly by the processor 40. The device 30 may have one or more memory 38 that may use different memory technologies including, but not limited to, Random Access Memory (RAM), Read Only Memory (ROM), flash memory, etc. The data in RAM is volatile meaning that it remains only as long as the device is turned on. When the device is turned off, RAM loses its data. The values stored in ROM are always there, whether the device is on or not. Flash memory is a type of constantly-powered non-volatile memory that can be erased and reprogrammed in units of memory called blocks.

The processor 40 may retrieve a set of instructions such as the access controlled program 42 from a non-volatile or a permanent memory and copy the instructions in an executable form to a temporary memory. The temporary memory is generally some form of RAM. The processor 40 executes a program or a utility such as the access controlled program 42, meaning that it performs the operations called for by that instruction set. The processor 40 may be implemented as a special purpose computer, logic circuits, hardware circuits, etc. Thus, the processor 40 may be implemented in hardware, firmware, software, or any combination of these methods.

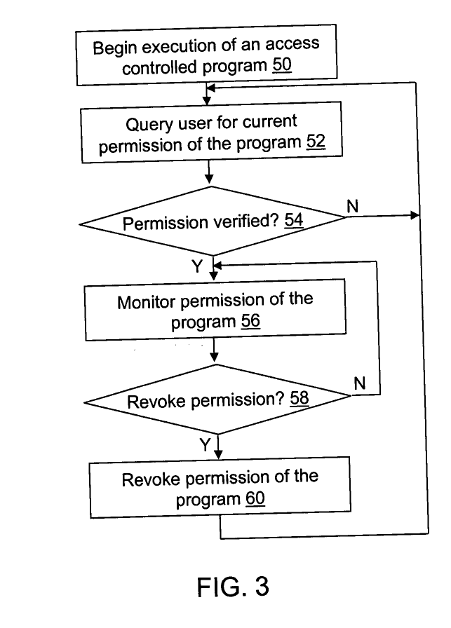

The access controlled program 42 is an organized set of instructions that include adjustable permission control operations. A program is an organized list of instructions that, when executed, cause the processor 40 to behave in a predetermined manner. A program is translated into a machine language that the processor 40 can understand and is stored on computer readable media such as the memory 38. As known to those skilled in the art, the operations may be implemented using various algorithms and may be written in one or more computer language including, but not limited to a high level language, a scripting language, an assembly language, etc. With reference to FIG. 3, the operations of the access controlled program 42 are described. The operations may be changed in order of execution without deviating from the spirit of the invention. Additional operations of the access controlled program may perform any number of applications including drafting documents, preparing presentations, creating movies and music, taking pictures, maintaining schedules, playing games, conducting e-commerce functions, messaging, etc. The access controlled program 42 includes the adjustable permission control operations described with reference to FIG. 3.

At operation 50, execution of the access controlled program 42 begins. The access controlled program 42, for example, may be a MIDlet downloaded by the user from a web server or a native application. Execution may be initiated by the user or may automatically execute based on parameters controlled by the user. At operation 52, the user is queried to allow the access controlled program 42 access to protected software modules. The query, for example, may use an authentication mechanism such as a Basic or Digest authentication mechanism using a username and a password or a X.509 PKI security standard. The username and password may be defined by the user or by the web server from which the access controlled program 42 is downloaded. At operation 54, a test is performed to determine if the requested permission is verified. If the permission is not verified, the user is again queried to provide the permission at operation 52. At operation 56, if the permission is verified, permission for the access controlled program 42 is monitored. Based on monitoring the permission of the access controlled program 42, a test is performed at operation 58 to determine if the permission should be revoked.

For example, revocation of the permission may result when a specified time interval has elapsed. A time interval for revoking the permission may be defined by the user or within the access controlled program 42. The elapsed time interval for executing the access controlled program 42 may be compared to the time interval. If the elapsed time interval is greater than or equal to the time interval, the permission may be revoked for the access controlled program 42. As an additional example, revocation of the permission may result when the access controlled program 42 use meets a predetermined use threshold. For example, for a MIDlet, application use can be measured by executed byte code instructions and for a native application, use can be measured by executed program code instructions. The predetermined use threshold may be defined by the user or within the access control program. A counter can be included for counting the executed program code or byte code instructions and the counter value can be compared to the predetermined use threshold. If the counter value is greater than or equal to the predetermined use threshold, the permission may be revoked for the access control program 42. The revocation of permission may be implemented by the developer of the access controlled program 42 as known to those skilled in the art. If revocation of the permission is not required, monitoring of the permission of the access controlled program 42 continues at operation 56. If revocation of the permission is determined to be required, the current permission of the access controlled program 42 is revoked at an operation 60. Processing continues at operation 52 to query the user for a new permission to verify use of the new functionality by the access controlled program 42.

It is understood that the invention is not confined to the particular embodiments set forth herein as illustrative, but embraces all such modifications, combinations, and permutations as come within the scope of the following claims. Thus, the description of the exemplary embodiments is for purposes of illustration and not limitation.

What is claimed is:

1. A method of revoking a permission of an access controlled program, the method comprising:
executing an access controlled program by a processor at a device;
determining if a permission of the access controlled program at the device needs to be revoked; and
requesting a new permission for the access controlled program at the device if the permission is determined to need revocation.

2. The method of claim 1, wherein determining if a permission of the access controlled program at the device needs to be revoked comprises:
identifying a time interval to revoke the permission;
determining an elapsed time interval for executing the access controlled program;
comparing the elapsed time interval to the time interval to revoke the permission; and
revoking the permission if the elapsed time interval is greater than or equal to the time interval to revoke the permission.

3. The method of claim 2, further comprising querying the user for a new permission for the access controlled program.

4. The method of claim 1, wherein the access controlled program is a mobile information device profile program.

5. The method of claim 1, wherein determining if a permission of the access controlled program at the device needs to be revoked comprises:
determining the number of access controlled program instructions executed by the processor at the device;
comparing the number of access controlled program instructions executed by the processor at the device to a predetermined use threshold; and
revoking the permission if the number of access controlled program instructions executed by the processor at the device exceeds the predetermined use threshold.

6. One or more computer-readable media having computer-readable instructions stored thereon that, upon execution by a processor, cause the processor to revoke a permission to use an access controlled program, the instructions configured to:
execute an access controlled program;
determine if a permission of the access controlled program needs to be revoked; and
request a new permission for the access controlled program at the device if the permission is determined to need revocation.

7. The computer-readable media of claim 6, wherein the instructions configured to determine if a permission of the access controlled program needs to be revoked comprises instructions configured to:
identify a time interval to revoke the permission;
determine an elapsed time interval for executing the access controlled program;
compare the elapsed time interval to the time interval to revoke the permission; and
revoke the permission if the elapsed time interval is greater than or equal to the time interval to revoke the permission.

8. The computer-readable media of claim 7, further comprising instructions configured to query the user for a new permission to verify use of the new functionality by the access controlled program.

9. The computer-readable media of claim 6, wherein the access controlled program is a mobile information device profile program.

10. The computer-readable media of claim 6, wherein the instructions configured to determine if a permission of the access controlled program needs to be revoked comprises instructions configured to:
determine the number of access controlled program instructions executed by the processor at the device;
compare the number of access controlled program instructions executed by the processor at the device to a predetermined use threshold; and
revoke the permission if the number of access controlled program instructions executed by the processor at the device exceeds the predetermined use threshold

11. A device for revoking a permission of an access controlled program, the device comprising:
an access controlled program, the access controlled program comprising computer-readable instructions configured to:
execute an access controlled program;
determine if a permission of the access controlled program needs to be revoked; and
request a new permission for the access controlled program at the device if the permission is determined to need revocation;
a memory, wherein the memory stores the access controlled program; and
a processor coupled to the memory, the processor configured to execute the access controlled program.

12. The device of claim 11, wherein the computer-readable instructions configured to determine if a permission of the access controlled program at the device needs to be revoked comprises instructions configured to:
identify a time interval to revoke the permission;
determine an elapsed time interval for executing the access controlled program;
compare the elapsed time interval to the time interval to revoke the permission; and
revoke the permission if the elapsed time interval is greater than or equal to the time interval to revoke the permission.

13. The device of claim 12, further comprising instructions configured to query the user for a new permission for the access controlled program.

14. The device of claim 11, wherein the access controlled program is a mobile information device profile program.

15. The device of claim 11, wherein the computer-readable instructions configured to determine if a permission of the access controlled program at the device needs to be revoked comprises instructions configured to:
determine the number of access controlled program instructions executed by the processor at the device;
compare the number of access controlled program instructions executed by the processor at the device to a predetermined use threshold; and
revoke the permission if the number of access controlled program instructions executed by the processor at the device exceeds the predetermined use threshold
